(19) United States
(12) Patent Application Publication
(10) Pub. No.: US 2003/0159472 A1
(43) Pub. Date: Aug. 28, 2003

(54) Apparatus for producing a soot preform

(75) Inventors: Shinji Nakahara, Yokohama-shi (JP); Tatsuo Saito, Yokohama-shi (JP); Kazuki Kunitake, Yokohama-shi (JP)

Correspondence Address: McDermott, Will & Emery, 600 13th Street, N.W., Washington, DC, 20005-3096, US

(73) Assignee: SUMITOMO ELECTRIC INDUSTRIES, LTD.

(21) Appl. No.: 10/359,054

(22) Filed: Feb. 6, 2003

(30) Foreign Application Priority Data
Feb. 22, 2002 (JP) 2002-046467
Dec. 17, 2002 (JP) 2002-364726

(51) Int. Cl. G01N 21/43

(52) U.S. Cl. 65/485

(57) ABSTRACT

A laser beam emitted from a laser element is received by a laser receiver. The soot deposition process is carried out by controlling a growing shoot deposition surface at a constant specified position based upon information carried by the received laser beam. The laser receiver is provided with a filter for absorbing heat rays generated by a burner flame and a heat shielding plate made of material having a high heat resistance to prevent the temperature of the receiver from rising. The receiver is also cooled with a stream of cooling gas. The above-described arrangement can prevent the occurrence of malfunction of the sensor portion due to its temperature rise and assures the reliable position control of the soot deposition, achieving a high accuracy of the soot perform produced.

### BACKGROUND OF THE INVENTION

The present invention relates to an apparatus for producing a soot (glass particles) deposited preform and, more specifically, to an apparatus for producing a soot preform, which is capable of accurately performing a soot process of depositing fine glass particles on a starting glass rod for an optical fiber preform.

As a method for producing a cylindrical soot preform to be used as an optical fiber preform, there is a so-called VAD process (Vapor Axial Deposition process). This process is carried out in such a manner that gas of glass particle raw material such as SiCl₄ and GeCl₄ together with combustible gas such as H₂ and combustion improver such as O₂ is fed through a burner and the glass raw material is hydrolyzed and oxidized by flame and converted into glass particles that are then deposited in the form of a soot (fine glass particles) layer on the cylindrical surface of the starting glass rod. The soot body thus produced is dehydrated and sintered to form a transparent soot body to be further drawn into a preform of an objective optical fiber, etc.

During the process of forming a soot body by the above-mentioned VAD method, a specified position on a soot deposition surface is monitored by a detecting means such as a laser-emitting element and a laser receiver or a CCD camera and the starting glass rod is always rotated and gradually moved upward to keep a constant specified distance between the specified position on the soot deposition surface and the burner.

For example, Japanese Laid-Open Patent Publication No. 5-193974 discloses a method of controlling a constant distance between the soot deposition surface and the burner in the process of forming soot body on a starting glass rod being continuously moved upward, whereby a lifting speed of the rotating starting glass rod is controlled by a change in quantity of light received by a light receiver due to interception by the bottom end of the soot body so as to maintain a specified distance between the bottom end of the soot body and the burner.

However, a sensing portion of the detecting means such as the laser receiver or the CCD camera for monitoring the soot deposition surface does not possess heat resistance enough to work at a short distance from the burner. If the detecting means should be exposed for a long time to heat rays produced by a flame from the burner, it may become unable to correctly receive a laser light or illumination or accurately detect the received light quantity. In this case, the detecting means can not accurately detect the soot deposition surface, failing in controlling the constant location of the soot body from the burner. As the result of this, the soot body can not be formed uniformly in its shape and soot density.

### SUMMARY OF THE INVENTION

An object of the present invention is to provide an apparatus for producing a soot preform by depositing glass particles on an external cylindrical surface of a starting glass rod to continuously form a soot body having a uniform shape and uniform soot density by continuously monitoring the soot deposition and correctly controlling the soot deposition position of the growing soot body with use of a detecting means (a light-receiver or CCD camera) which is surely protected against heat rays from the soot process by preventing not to be exposed for a long time in the high temperature environment and can thereby carry out the continuous and correct monitoring the growing soot body surface through the soot process without malfunctioning.

Another object of the present invention is to provide an apparatus for producing a soot preform, which is provided with a burner generating heat rays and synthesizing and depositing glass particles (soot) on a starting glass rod and a detecting means having a light receiving portion for sensing a light beam carrying optical information about a specified position of a growing soot deposition and which is capable of controlling the specified position of the soot deposition based on the received optical information, wherein the sensing portion of the detecting means is protected against the heat rays by using a filter capable of reliably shutting off or attenuating the incident heat rays.

### BRIEF DESCRIPTION OF DRAWINGS

FIG. 1 is a schematic view of an apparatus for producing a soot preform, which is an embodiment of the present invention.

FIG. 2 is a schematic perspective view for explaining the construction of a laser receiver and a filter device for the laser receiver of the apparatus shown in FIG. 1.

FIG. 3 is a perspective illustration of an exemplary cooling means for cooling the detecting means.

FIG. 4 is a schematic view of an apparatus for producing a soot preform, which is another embodiment of the present invention.

FIG. 5 is a schematic view of an apparatus for producing a soot preform, which is a further embodiment of the present invention.

FIG. 6 is a schematic view of an apparatus for producing a soot preform, which is a still further embodiment of the present invention.

FIG. 7 is a schematic illustration of another exemplary arrangement of the filter device.

FIG. 8 is a schematic illustration of further exemplary arrangement of the filter device.

### PREFERRED EMBODIMENT OF THE INVENTION

A soot-preform production apparatus according to a preferred embodiment of the present invention will be described below in detail with reference to accompanying drawings wherein components being similar in function are identified by the same numbers and described in detail for once without further repetition.

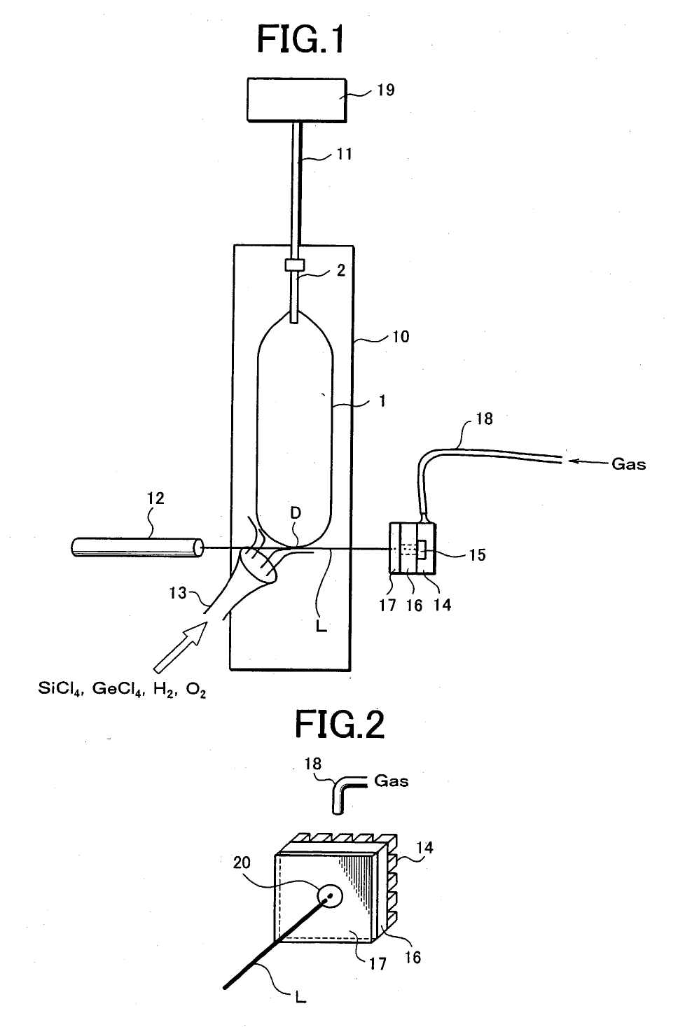

FIG. 1 is a schematic illustration of a soot preform production apparatus according to a preferred embodiment of the present invention. In FIG. 1, there is shown a soot body 1, a starting glass rod 2, a reaction vessel 10, a supporting bar 11 for holding the staring glass rod, a laser element 12, a burner 13 for producing glass particles (hereinafter referred to as a burner), a laser receiver 14, a laser receiving portion 15, a heat shielding plate 16, a filter 17, a hose (or tubing) 18 for supplying cooling gas, a rotary elevating mechanism 19, a detecting position D on a soot body surface and a laser beam L.

For production of a soot preform, a seed (core) rod 2 serving as a starting member (hereinafter referred as to “starting glass rod”) is connected at its one end to a supporting bar 11 that can be rotated about its axis and moved in vertical direction by the rotary elevating mechanism 19. The rotary elevating mechanism 19 is driven to suspend the free end of the starting glass rod 2 into the reaction vessel 10 in which the soot deposition process is then started. Namely, gas of glass particle raw material such as SiCl₄ and GeCl₄ together with combustible gas such as H₂ and combustion improver such as O₂ is fed through the burner 13 and the glass raw material is hydrolyzed and oxidized by flame from the burner and converted into fine glass particles (soot) that are then deposited on the surface of the starting glass rod 2 being rotated.

As the soot process proceeds, the deposition surface of the soot body 1 formed on the starting glass rod 2 grows in the axial direction thereof and, therefore, the starting glass rod 2 is gradually lifted by the rotary elevating mechanism 19 so that the deposition surface of the soot body can be always maintained at a constant level.

The shoot-preform production apparatus according to the present invention incorporates a detecting means for monitoring the specified position of the soot body 1 and controls the vertical movement of the starting rod 2 (supporting bar 11) according to a detection signal from the detecting means to always maintain a specified vertical level position of the growing soot body surface during the soot process.

In the embodiment shown in FIG. 1, the detecting means is composed of a laser element 12 for emitting a laser beam for detecting the specified soot deposition position and a laser receiver 14 for receiving by its laser receiving portion 15 the laser beam emitted from the laser element and the operation of the rotary elevating mechanism 19 is controlled, based on the detection signal from the laser receiver, to lift the starting glass rod 2 so that the soot deposition surface of the soot body 1 may be always kept at a specified position. In the shown example, the laser beam always pass a detecting position D and the rotary elevating mechanism 19 is controlled to adjust the starting glass rod so that the bottom end of the soot body may be located on the detecting position D.

The embodiment of FIG. 1 uses the laser receiver 14 which may malfunction while working at a high ambient temperature. To prevent the possible malfunction of the laser receiver 14 due to the affection of the ambient temperature, the filter 17 capable of shutting off or attenuating heat rays transmitted from a flame of the burner 13 is disposed on a path line of a laser beam between the laser element 12 and the laser receiver 14. In addition, the heat shielding plate 16 made of heat-insulating material is provided between the burner 13 and the laser receiver 14 to prevent the casing of the receiver 14 from being heated by heat rays.

FIG. 2 is a schematic perspective view showing the construction of the filter and the heat shielding plate shown in FIG. 1. In this example, the filter 17 and the heat shielding plate 16 are integrally attached in layers to a beam-receiving surface of the laser receiver 14 and in the order of the heat shielding plate 16 and the filter 17 from the light-receiving side as shown in FIG. 1. It is noted that the arrangement of the heat shielding plate 16 and the filter 17 is not limited to the shown example and may be changed to the order of the filter 17 and the heat shielding plate 16 from the light-receiving side.

The laser receiver 14 thus protected against the heat rays by the combination of the filter 17 with the heat shielding plate 16 can reliably detect the growing surface of the soot body during the soot deposition process.

In the embodiment using the laser receiver 14, there is used the filter 17 capable of passing light having frequencies corresponding to the laser beam emitted by the laser element and cutting off or attenuating heat rays so as not to rise the ambient temperature or capable of separating the laser beam from the heat rays. For example, a heat-absorbing glass and a dielectric multilayer filter (interference filter) diffraction grating can be preferably used as the filter 17.

The heat shielding plate 16 is preferably made of material having the high heat-insulating property to protect the laser receiver 14 against heat rays transmittable from the flame of the burner 13 and the soot body 1 during the soot deposition process. For example, the plate 16 may be made of, not restricted to, phenol resin (e.g., bakelite(TM)), fluoride resin (polytetrafluoroethylene, e.g., Teflon(TM)), polyimide, carbon, metal (e.g., stainless, aluminum and iron) and ceramic material. Other kinds of material having excellent heat-insulating and heat-resisting properties may be also used in practice.

The heat shielding plate 16 has a through hole 20 of suitable diameter in a specified optical path potion thereof to allow a laser beam from the laser element 12 to pass and reach at the light-receiving portion 15 of the laser receiver 14. The diameter of the through hole 20 made in the heat shielding plate 16 is preferably equal to or somewhat larger than a spot diameter of laser beam L to minimize the quantity of heat rays incident to the laser receiver 14. The thickness of the heat shielding plate 16 is preferably large as possible to eliminate the effect of heat rays incident at angles to the through hole 20. When the heat shielding plate 16 made of transparent material is used, it may not always have a through hole 20 if the optical path is assured therein. The filter 17 does not require the provision of the through hole since it allows the laser beam to pass there through.

Heat rays that may increase the temperature of the detecting means are not only generated by a flame of the burner 13 but also radiated from the soot body 1. So, the heat shielding plate 16 and the filter 17 is preferably arranged to surround the laser receiver 14 to effectively shut off the incident heat rays.

An example of a cooling means used for cooling the detecting means will be described below. FIG. 3 is a perspective view of an exemplary cooling means for cooling a detecting means. The cooling means of FIG. 3 is to cool the laser receiver 14 by radiating heat thereof through a radiating panel 21 made of material having excellent heat conductivity, for example metal, and disposed in contact with the laser receiver 14. The radiating panel 21 is arranged to surround the laser receiver 14 to assure high cooling efficiency.

The radiating panel 21 is preferably disposed at a place where the heat rays can be shut off or attenuated by the heat shielding plate 16 and the filter 17. The radiating plate 21 can be also disposed on the rear side of the laser receiver 14, which side is reverse to the direction of incoming heat rays. It is also possible to make a whole or a part of casing of the laser receiver 14 from metal or like material having excellent heat conductivity.

Furthermore, the laser receiver 14 is protected against heat rays by cooling with cooling gas applied to its protection casing or the radiating plate 21. A stream of the cooling gas is directed through a hose (or tubing) 18 to the radiating panel 21 or the protection casing of the laser receiver 14 (or a CCD camera). As the cooling medium is used incombustible and low-aggressive gas such as N₂, He, Ar, O₂, or compressed air. The compressed air is most economical and enough to cool the object at high cooling efficiency. A stream of air cooled by an air conditioner can be also used for the above purpose.

It is also possible to cool the laser receiver with cooling liquid such as water and oil, which is supplied by tubing arranged around the casing thereof.

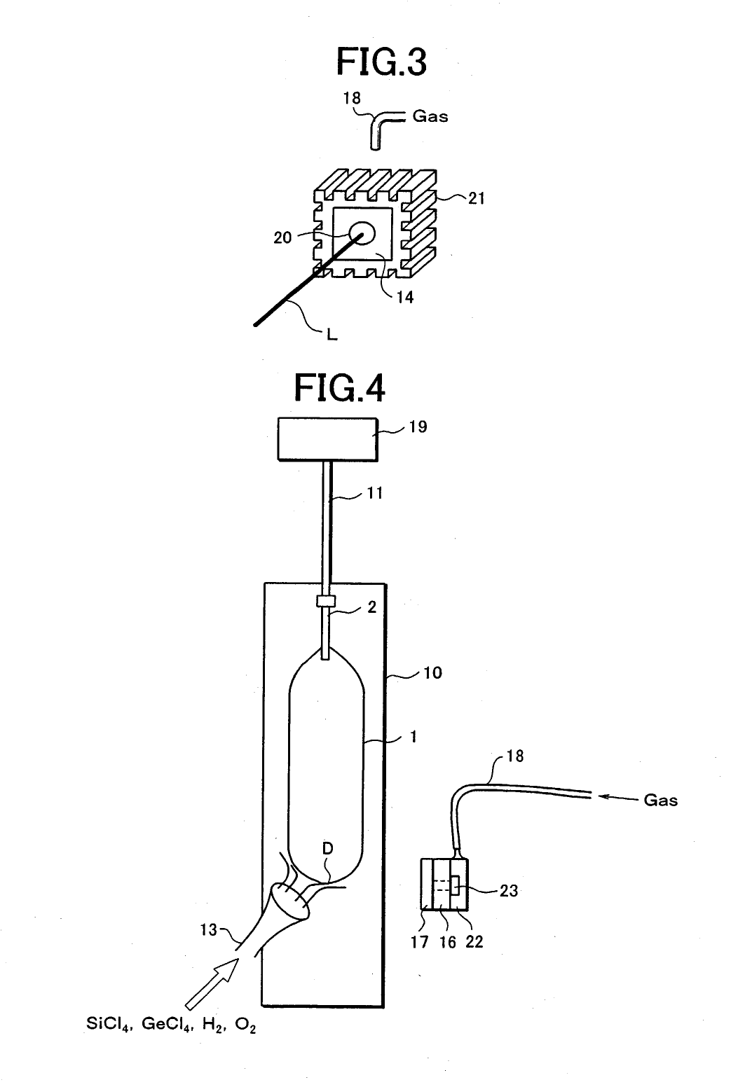

FIG. 4 is a schematic illustration of a soot preform production apparatus according to another embodiment of the present invention. In FIG. 4, there is shown a CCD camera 22 and a light receiving portion 23 of the CCD camera. The embodiment of FIG. 4 is different from the apparatus of FIG. 1 by the provision of the CCD camera 22 as a detecting means for detecting a soot deposition surface of a soot preform.

A filter 17 and a heat shielding plate 16 are integrally mounted in layers on the front surface of the light-receiving portion of the CCD camera 22. The filter 17 possesses the optical characteristics of passing visible light and cutting off or attenuating heat rays or separating the laser beam from the radiation rays. As the filter 17 is suitably applied a heat-absorbing glass or a dielectric multilayer filter diffraction grating used in the embodiment of FIG. 1. The heat-absorbing glass capable of cutting off heat rays is preferably used for this application.

The heat shielding plate 16 made of material having excellent heat insulating property, which is applied in the embodiment of FIG. 1, is also used in this embodiment. The filter 17 and the heat shielding plate 16 are constructed as shown in FIG. 2. A through hole 20 in the heat shielding plate serves as an inlet allowing detection light to pass there through and enter the light-receiving portion. The heat shielding plate 16 made of transparent material may not have a through hole 20 if the optical path for the detection light is assured therein.

The CCD camera 22 can be provided with the radiating panel 21 as shown in FIG. 3 or a protection casing which is completely or partially made of material having excellent heat conductivity and thereby assuring an increased cooling effect. In addition, the radiating panel 21 or the protection casing of the CCD camera is cooled with a stream of cooling gas applied thereto for eliminating the effect of heat rays. Other cooling construction similar to that described for the embodiment of FIG. 1 may also be applied for this embodiment.

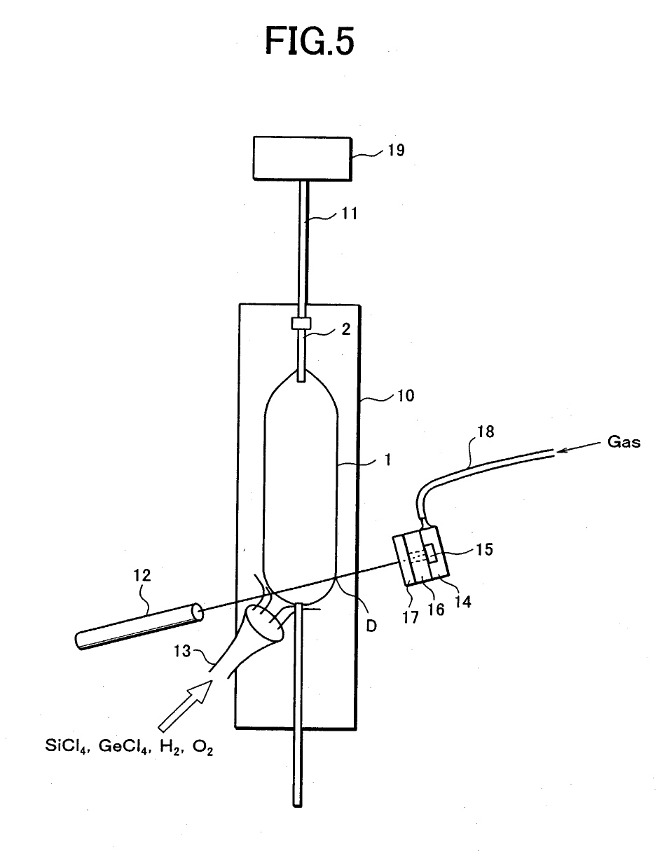

FIG. 5 is a schematic illustration of a soot preform production apparatus according to a further embodiment of the present invention. This embodiment differs from the embodiment of FIG. 1 by the detecting position D of soot deposition, which is set at a specified position on the side surface of the growing soot body (not at the bottom end of the soot body as shown in FIG. 1). The other components of this embodiment are not described since they are similar to those of the embodiment of FIG 1.

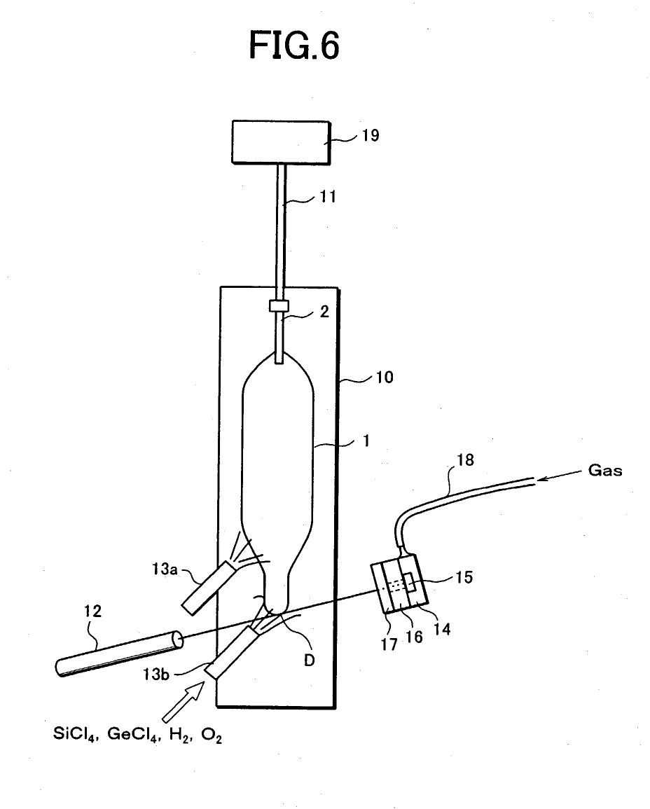

FIG. 6 is a schematic illustration of a soot preform production apparatus according to a still further embodiment of the present invention. In FIG. 6, numerals 13a and 13b designate respective burners for generating glass particles (soot). In this embodiment, soot deposition is carried out by two burners 13a and 13b respectively. In this case, the detecting position D of the soot deposition is at the bottom end of the growing soot body. The other components of this embodiment are not described since they are similar to those of the embodiment shown in FIG. 1.

Another exemplary arrangement of the heat shielding plate and the filter is now described. Although the heat shielding plate 16 and the filter 17 are integrally mounted in layers on the surface of the laser receiver or the surface of the light-receiving portion of the CCD camera in the above described embodiments, they may be arranged together at any suitable place where they can reliably shutting off or attenuating heat rays from the soot process and/or may be arranged separately from each other.

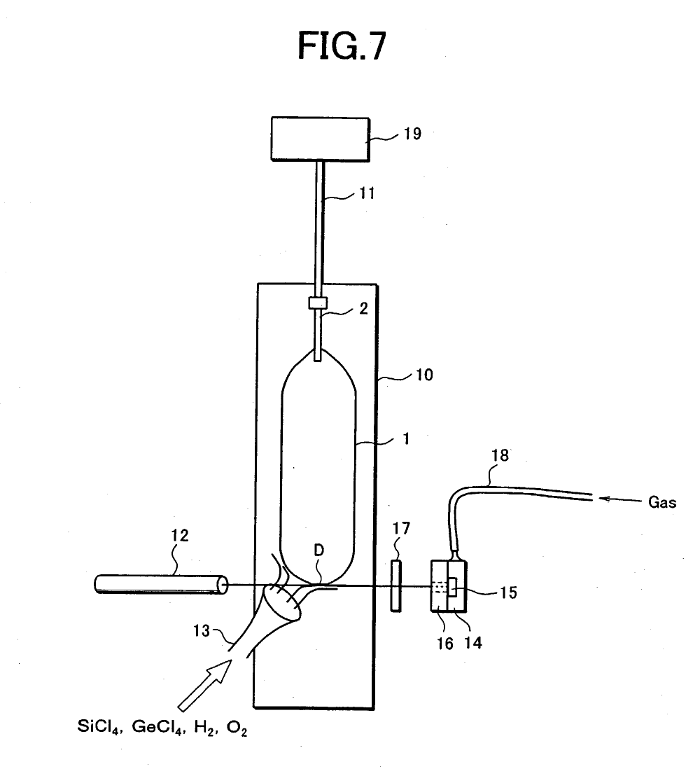

FIG. 7 is a schematic illustration of another exemplary arrangement of the heat shielding plate and the filter. In this example, as shown in FIG. 7, the heat shielding plate 16 is disposed on the laser beam receiving portion 14 and the filter 17 is separated from the former and disposed nearer to the burner 13.

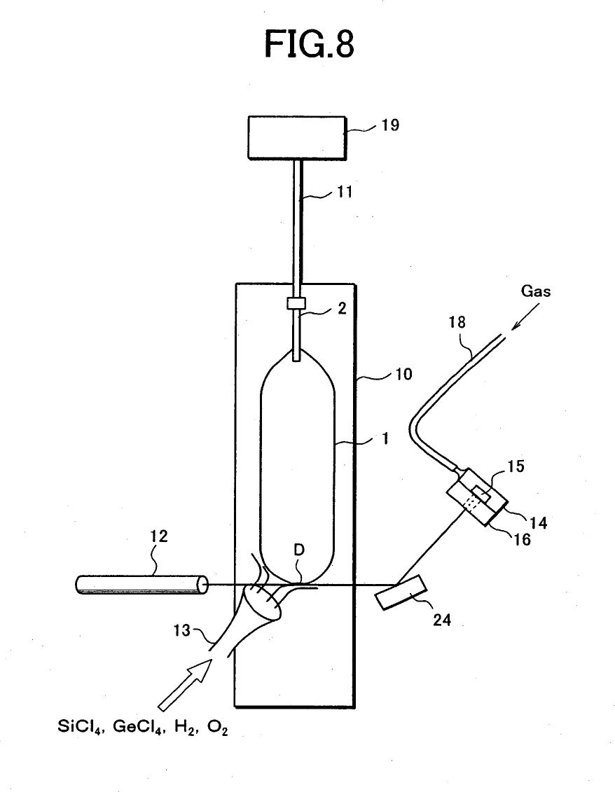

FIG. 8 is a schematic illustration of a further exemplary arrangement of the heat shielding plate and the filter. In FIG. 8, numeral 24 designates a reflecting plate. In the shown arrangement, the reflecting plate 24 is disposed on the optical path of the laser beam from the laser element 12 to reflect the beam to the laser receiver 14. The laser receiver 14 receives the laser beam through a heat shielding plate 16 disposed on its light receiving surface.

The reflecting plate 24 may be a mirror (cold mirror) having a multilayer dielectric film allowing infrared rays to pass there through and reflecting visible light or a mirror using an interference filter capable of attenuating or dissipating infrared rays in a multilayer dielectric film. The reflecting plate 24 can separate a beam of light for detecting the soot deposition from heat rays which are then attenuated or dissipated not to reach the light receiving portion of the detecting means. Namely, the provision of the reflecting plate 24 can increase a distance between the burner generating the majority of heat rays and the light receiving portion of the detecting means by changing the direction of the detection light thereat without increasing the size of the detecting means.

In the arrangements shown in FIGS. 5 to 8, the laser element 12 and the laser receiver 14 may be replaced with a CCD camera for detecting the soot deposition surface.

(Practical Use of an Embodiment)

A practical example of the soot preform production apparatus according to the present invention is now described below. In the soot preform production apparatus shown in FIG. 1, the light receiving surface of the laser receiver 14 was covered with superposed layers of a filter 17 and a heat shielding plate 16. The heat shielding plate 16 was a 10 mm thick sheet of Teflon(TM) having a through hole 20 of 5 mm in diameter, which was made in a portion corresponding to the optical path of a laser beam. The filter 17 was made of heat absorbing glass and then superposed on the heat shielding plate 16 made of Teflon(TM) to form a layered block as shown in FIG. 2. The filter 17 made of 3 mm thick heat-absorbing glass possessed the transparency of 85.5% for visible light, transparency of 89.0% for ultraviolet rays and transparency of 0.3% or less than 0.3% for infrared rays.

Furthermore, the protection casing of the laser receiver 14 was cooled with compressed air supplied at a flow rate of 15 to 20 liters per minute to cool the laser receiver 14. The above arrangement could effectively prevent the occurrence of malfunction of the laser receiving portion 15 due to heating by heat rays. As the result of this, the apparatus could produce a soot preform (to be drawn to form an optical fiber product), which preform attained the uniform shape of the soot body and the continuous and uniform density of glass particles therein.

As is apparent from the foregoing, the provision of the heat shielding and filtering members for protecting the laser receiver or the light sensor of the CCD camera for detecting the growing soot deposition surface can prevent the laser receiver and the CCD camera from opposed directly to high temperature of the atmosphere for a long time. This can prevent the occurrence of malfunction of the laser receiver and the CCD camera from the affection of heat rays and enables the detecting means to reliably perform accurate detection of the growing soot deposition surface. The increased reliability of detection of the soot deposition surface enables the apparatus to produce a soot preform (to be further drawn to form an optical fiber product), which has a uniform shape of the soot body and continuous and uniform density of glass particles therein.

1. An apparatus for producing a soot preform, comprising a burner for generating heat rays and at the same time synthesizing glass particles and depositing said glass particles on a starting glass rod, a detector having a light receiving portion for detecting a light beam carrying optical information about a specified position of a soot deposition surface, and a controller controlling the specified position of the soot deposition surface based upon the optical information, wherein a filter capable of shutting off or attenuating the heat rays not to enter the light receiving portion is further provided.

2. An apparatus for producing a soot preform as defined in claim 1, wherein the filter is disposed on an optical path of the light beam.

3. An apparatus for producing a soot preform as defined in claim 1, wherein the filter absorbs heat rays.

4. An apparatus for producing a soot preform as defined in claim 1, wherein the filter reflects heat rays and transmits light other than heat rays.

5. An apparatus for producing a soot preform as defined in claim 1, wherein the filter separates heat rays from other light by diffraction therein.

6. An apparatus for producing a soot preform as defined in claim 2, wherein the filter is a reflector for reflecting the light beam therefrom to the light receiving portion, which reflector has a multilayer dielectric film on its reflecting surface.

7. An apparatus for producing a soot preform as defined in any one of claims 1 to 5, wherein a cooler is provided for cooling the detector with a stream of cooling gas or liquid.

8. An apparatus for producing a soot preform as defined in claim 1, comprising a heat radiator which makes the detector radiate its heat by at least one of contacting material having excellent heat conductivity to a laser casing surrounding the detector or making a part of the laser casing from the material having excellent heat conductivity.

9. An apparatus for producing a soot preform as defined in any one of claims 1 to 5, wherein the detector has a laser receiver for receiving a laser beam from a laser element.

10. An apparatus for producing a soot preform as defined in any one of claims 1 to 5, wherein the detector has a CCD camera for receiving the light beam from the specified position.

11. An apparatus for producing a soot preform as defined in any one of claims 1 to 5, wherein the detector has a heat shielding plate made of heat insulating material, which plate has the property of transmitting the light beam or has a through hole for transmitting said light beam.

12. An apparatus for producing a soot preform as defined in claim 7, comprising a heat radiator which makes the detector radiate its heat by at least one of contacting material having excellent heat conductivity to a laser casing surrounding the detector or making a part of the laser casing from the material having excellent heat conductivity.
